(19) United States
(12) Patent Application Publication
(10) Pub. No.: US 2025/0220255 A1
(43) Pub. Date: Jul. 3, 2025

(54) BANDWIDTH ALLOCATION METHOD AND APPARATUS, DEVICE, AND STORAGE MEDIUM

(71) Applicant: Beijing Zitiao Network Technology Co., Ltd., Beijing (CN)

(72) Inventor: Canrui WU, Beijing (CN)

(21) Appl. No.: 18/983,006

(22) Filed: Dec. 16, 2024

(30) Foreign Application Priority Data
Dec. 29, 2023 (CN) 202311865802.4

(51) Int. Cl. H04N 21/2385; H04N 21/2343

(52) U.S. Cl. CPC H04N 21/2385; H04N 21/234381

(57) ABSTRACT

The embodiments of the disclosure provide a bandwidth allocation method and apparatus, a device, and a storage medium. The method includes: determining a target estimated bandwidth corresponding to a plurality of video streams; determining a state degradation sequence corresponding to the plurality of video streams based on stream attribute information of each video stream, the state degradation sequence including a plurality of resolution states arranged in a degradation order, and each resolution state including a transmission resolution of each video stream; performing resolution-degraded bandwidth allocation process based on the state degradation sequence corresponding to the plurality of video streams, a current transmission resolution of each video stream and the target estimated bandwidth, to determine a target resolution state corresponding to the plurality of video streams; and transmitting the plurality of video streams based on the target resolution state.

### CROSS-REFERENCE TO RELATED APPLICATION(S)

This application claims priority to Chinese Application No. 202311865802.4 filed on Dec. 29, 2023, the disclosure of which is incorporated herein by reference in its entirety.

### FIELD

The embodiments of the disclosure relates to the computer technology, in particular to a bandwidth allocation method and apparatus, a device, and a storage medium.

### BACKGROUND

With the rapid development of the Internet technology; a plurality of video streams are required to be transmitted simultaneously, for their communication in real time. However, network congestion may occur during real-time communication due to network churn. As a result, an estimated bandwidth after network congestion is required to be allocated, in order to reduce a transmission bitrate of the video streams and satisfy transmission requirement for the estimated bandwidth. Thus, it is a pressing issue to develop a flexible and effective bandwidth allocation method for satisfying different service demands.

### SUMMARY

The disclosure provides a bandwidth allocation method and apparatus, a device, and a storage medium.

In a first aspect, an embodiment of the disclosure provides a bandwidth allocation method. The method includes: determining a target estimated bandwidth corresponding to a plurality of video streams; determining a state degradation sequence corresponding to the plurality of video streams based on stream attribute information of each video stream, the state degradation sequence including a plurality of resolution states arranged in a degradation order, and each resolution state including a transmission resolution of each video stream; performing resolution-degraded bandwidth allocation process based on the state degradation sequence corresponding to the plurality of video streams, a current transmission resolution of each video stream and the target estimated bandwidth, to determine a degraded target resolution state corresponding to the plurality of video streams; and transmitting the plurality of video streams based on a target transmission resolution of each video stream in the target resolution state.

In a second aspect, the embodiment of the disclosure further provides a bandwidth allocation apparatus. The apparatus includes: a target estimated bandwidth determination module configured to determine a target estimated bandwidth corresponding to plurality of video streams; a state degradation sequence determination module configured to determine a state degradation sequence corresponding to the plurality of video streams based on stream attribute information of each video stream, the state degradation sequence including a plurality of resolution states arranged in a degradation order, and each resolution state including a transmission resolution of each video stream; a target resolution state determination module configured to perform resolution-degraded bandwidth allocation process based on the state degradation sequence corresponding to the plurality of video streams, a current transmission resolution of each video stream and the target estimated bandwidth, to determine a degraded target resolution state corresponding to the plurality of video streams; and a video stream transmission module configured to transmit the plurality of video streams based on a target transmission resolution of each video stream in the target resolution state.

In a third aspect, the embodiment of the disclosure further provides an electronic device. The electronic device includes: one or more processors; and a storage apparatus configured to store one or more programs which, when executed by the one or more processors, cause the one or more processors to implement the bandwidth allocation method according to any one of the embodiments of the disclosure.

In a fourth aspect, the embodiment of the disclosure further provides a storage medium. The storage medium includes computer-executable instructions, where the computer-executable instructions, when executed by a computer processor, are configured to perform the bandwidth allocation method according to any one of the embodiments of the disclosure.

### BRIEF DESCRIPTION OF THE DRAWINGS

The above and other features, advantages and aspects of embodiments of the disclosure will become more apparent in conjunction with accompanying drawings and with reference to the following specific embodiments. Throughout the accompanying drawings, the same or similar reference numerals indicate the same or similar elements. It should be understood that the accompanying drawings are schematic and components and elements are not necessarily drawn to scale.

FIG. 1 is a schematic flowchart of a bandwidth allocation method according to an embodiment of the disclosure;

FIG. 2 is another schematic flowchart of a bandwidth allocation method according to an embodiment of the disclosure;

FIG. 3 is yet another schematic flowchart of a bandwidth allocation method according to an embodiment of the disclosure;

FIG. 4 is still another schematic flowchart of a bandwidth allocation method according to an embodiment of the disclosure;

FIG. 5 is a schematic structural diagram of a bandwidth allocation apparatus according to an embodiment of the disclosure; and

FIG. 6 is a schematic structural diagram of an electronic device according to an embodiment of the disclosure.

### DETAILED DESCRIPTION OF EMBODIMENTS

The embodiments of the disclosure will be described below in more detail with reference to the accompanying drawings. Although some embodiments of the disclosure are shown in the accompanying drawings, it should be understood that the disclosure can be implemented through various forms, and should not be constructed to be limited to the embodiments expounded herein. On the contrary, these embodiments are provided for more thorough and complete understanding of the disclosure. It should be understood that the accompanying drawings and the embodiments of the disclosure are only used for illustration rather than limitation to the protection scope of the disclosure.

It should be understood that steps described in a method embodiment of the disclosure can be executed in different orders and/or in parallel. Further, the method embodiment can include an additional step and/or omit a shown step, which does not limit the scope of the disclosure.

As used herein, the terms “comprise”. “include” and their variations are open-ended, that is, “comprise but not limited to” and “include but not limited to”. The term “based on” indicates “at least partially based on”. The term “an embodiment” indicates “at least one embodiment”. The term “another embodiment” indicates “at least another one embodiment”. The term “some embodiments” indicates “at least some embodiments”. Related definitions of other terms will be given in the following description.

It should be noted that concepts such as “first” and “second” mentioned in the disclosure are only used to distinguish different apparatuses, modules or units, rather than limit an order or interdependence of functions executed by these apparatuses, modules or units.

It should be noted that modifications with “a”, “an” and “a plurality of” mentioned in the disclosure are schematic rather than limitative, and should be understood by those skilled in the art as “one or more” unless otherwise definitely indicated in the context.

A name of messages or information exchanged among a plurality of apparatuses in the embodiment of the disclosure is only used for illustration rather than limitation to the scope of these messages or information.

It can be understood that the data involved in this technical solution (including but not limited to the data, obtainment or use of the data) should comply with the requirements of corresponding laws, regulations and relevant provisions.

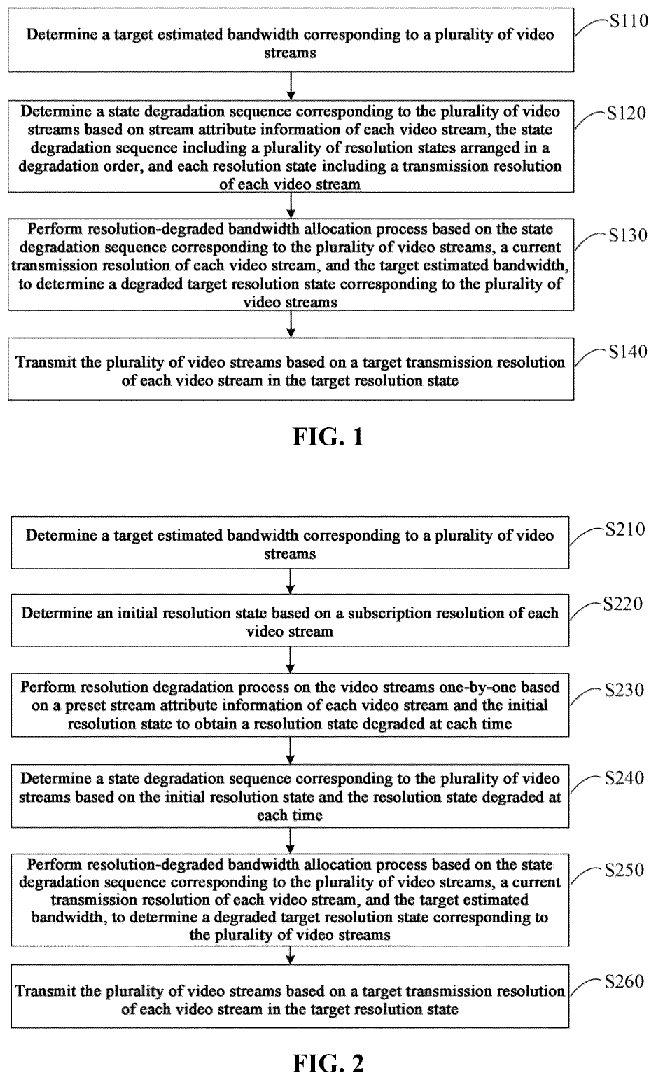

FIG. 1 is a schematic flowchart of a bandwidth allocation method according to an embodiment of the disclosure. The embodiment of the disclosure is applied to a case of bandwidth allocation of a plurality of video streams after network congestion. This method may be executed by a bandwidth allocation apparatus. This apparatus may be implemented in the form of software and/or hardware, optionally, implemented by an electronic device. The electronic device may be a mobile terminal, a personal computer (PC) terminal, a server, etc.

As shown in FIG. 1, the bandwidth allocation method specifically includes the following steps.

At S110, a target estimated bandwidth corresponding to a plurality of video streams is determined.

The network congestion may refer to a case of data stacking caused by a fact that a current transmission bitrate (that is, a current transmission bandwidth) at which the plurality of video streams are transmitted exceeds an actual network bandwidth. The target estimated bandwidth refers to a current value of bandwidth determined through a bandwidth estimation algorithm, which is required to transmit the plurality of video streams in order to alleviate the network congestion. The target estimated bandwidth may be configured to characterize a target transmission bitrate. The target transmission bitrate is less than the current transmission bitrate. Thus, the transmission bandwidth of the plurality of video streams is reduced by reducing the transmission bitrate.

Specifically, in a process of transmitting the plurality of video streams based on the current transmission bitrate, whether the network congestion occurs at present may be detected in real time, that is, whether data stacking occurs in a network cache is detected. In response to the network congestion being detected, the target estimated bandwidth suitable for current network transmission is determined through the bandwidth estimation algorithm based on a bandwidth detection result of the network congestion, so as to adjust the transmission bandwidth in time and ensure user experience of real-time communication.

At S120, a state degradation sequence corresponding to the plurality of video streams is determined based on stream attribute information of each video stream. The state degradation sequence includes a plurality of resolution states arranged in a degradation order, and each resolution state includes a transmission resolution of each video stream.

The stream attribute information may refer to attribute information of each video stream itself or currently. The stream attribute information may include static attribute information and dynamic attribute information. The dynamic attribute information may be dynamically changed based on a service operation. For example, a subscription resolution of the video stream may be allowed to be actively changed by a user, or a subscription resolution of the video stream may be automatically changed based on service demands. Exemplary, the stream attribute information of each video stream may include: the subscription resolution and preset stream attribute information. The subscription resolution may be a transmission resolution subscribed by a player end currently. For example, the subscription resolution is 180P or 360P or the like. The preset stream attribute information may be stream attribute information that is set in advance based on the service demands and may affect a resolution degradation order. For example, the preset stream attribute information includes at least one of: whether a video stream being a shared video stream, whether a video stream being a video stream of an active speaker, whether a frame being droppable and resolution degradable times of each transmission resolution. The shared video stream refers to a video stream that needs to be shared with other player ends. Whether the frame is droppable may be determined based on whether the video stream is coded based on scalable video coding (SVC). The SVC is to divide a video code stream into a plurality of layers, and can discard some or all segments of some layers according to priority of the layers, as long as a decodability of an entire stream is guaranteed. In response to a video stream being coded based on SVC, it is determined that a frame of the video stream can be dropped, otherwise, it is determined that a frame of the video stream cannot be dropped. The resolution degradable times of each transmission resolution may be times for gradually degrading the transmission resolution to a lowest resolution. For example, in response to resolution levels from high to low including: 720P, 360P, 180P, 90P, and 0P, the resolution degradable times of the transmission resolution of 720P may be 4, the resolution degradable times of the transmission resolution of 360P may be 3, and resolution degradable times of the transmission resolution of 180P may be 2. The resolution of 0P indicates that the video stream is closed or stopped.

The state degradation sequence may include a plurality of resolution states arranged in a resolution degradation order. Each resolution state includes the transmission resolution of each video stream. Different transmission resolutions correspond to different resolution states. The state degradation sequence may be dynamically determined based on different types of stream attribute information. The state degradation sequence may be used to characterize a degradation path or a simple state machine. For example, Table 1 gives an example of the state degradation sequence. With reference to Table 1, the state degradation sequence 1 includes five resolution states that are arranged in a degradation sequential order. A resolution state 1 is a non-degraded state, and may be determined based on the subscription resolution of the video stream. A resolution state 5 is a lowest degraded state. Each resolution state includes transmission resolutions of two video streams A and B.

TABLE 1
Information of the
state degradation sequence
State degradation sequence 1

| | Video | Video |
|---|---|---|
| Resolution state | stream A | stream B |
| Resolution state 1 | 180 P | 180 P |
| Resolution state 2 | 180 P | 90 P |
| Resolution state 3 | 90 P | 90 P |
| Resolution state 4 | 90 P | 0 P |
| Resolution state 5 | 0 P | 0 P |

Specifically, based on the stream attribute information of each video stream and a current resolution state, degradation priority of each video stream in the current resolution state may be determined, and a target video stream that needs to be degraded in the current resolution state is determined based on the degradation priority. A next resolution state is obtained by preforming resolution degradation process on the target video stream. Similarly, subsequent resolution states are determined one-by-one until a lowest resolution state is determined, that is, the transmission resolution of each video stream is the lowest resolution, such as 0P. Thereby, the state degradation sequence corresponding to the plurality of video streams may be dynamically determined based on different types of stream attribute information, and the resolution degradation may be performed based on the state degradation sequence. Flexible configuration of the resolution degradation order can be implemented, and different service demands are satisfied.

At S130, resolution-degraded bandwidth allocation process is performed based on the state degradation sequence corresponding to the plurality of video streams, a current transmission resolution of each video stream and the target estimated bandwidth, to determine a degraded target resolution state corresponding to the plurality of video in streams.

The current transmission resolution indicates a resolution of the video stream currently transmitted, that is, the transmission resolution of the video stream when the network congestion occurs. The resolution degradation may indicate reduction of the transmission bandwidth of the video stream by reducing the resolution. The lower the transmission resolution of the video stream is, the smaller the transmission bandwidth needed is. By determining the appropriate transmission resolution of each video stream, the target estimated bandwidth may be allocated, such that the plurality of video streams are transmitted through the target estimated bandwidth. The target resolution state may be an optimal resolution state that satisfies the transmission requirement for the target estimated bandwidth. For example, the target resolution state may be the resolution state for which the transmission bandwidth needed is closest to the target estimated bandwidth.

Specifically, based on a resolution state order in the state degradation sequence corresponding to the plurality of video streams and the current transmission resolution of each video stream, one target resolution state, for which a transmission may be performed through the target estimated bandwidth, is determined from the state degradation sequence. For example, a transmission bandwidth corresponding to each resolution state in the state degradation sequence is estimated respectively, and a resolution state corresponding to the transmission bandwidth that is closest to the target estimated bandwidth is determined as the target resolution state. Thus, the target estimated bandwidth can be allocated flexibly and effectively through the resolution degradation.

At S140, the plurality of video streams are transmitted based on a target transmission resolution of each video stream in the target resolution state.

Specifically, corresponding video streams are transmitted based on the target transmission resolution of each video stream in the target resolution state, such that a total transmission bandwidth of all video streams is the target estimated bandwidth or closest to the target estimated bandwidth. Thus, the transmission bandwidth is reduced, the network congestion is alleviated, and user experience of real-time communication is further guaranteed.

According to the technical solution of the embodiment of the disclosure, the state degradation sequence corresponding to the plurality of video streams can be dynamically determined based on the stream attribute information of each video stream. The state degradation sequence includes the plurality of resolution states arranged in a degradation order, and each resolution state includes the transmission resolution of each video stream. Different types of stream attribute information can correspond to different resolution degradation orders, the resolution degradation orders are dynamically determined, and the different service demands are further satisfied. The resolution-degraded bandwidth allocation process is performed based on the state degradation sequence corresponding to the plurality of video streams, the current transmission resolution of each video stream and the target estimated bandwidth corresponding to the plurality of video streams, to determine the degraded target resolution state corresponding to the plurality of video streams. The plurality of video streams are transmitted based on the target transmission resolution of each video stream in the target resolution state. Thus, the flexible and effective bandwidth allocation is performed through the resolution degradation, and the transmission requirement for the estimated bandwidth and the different service demands are satisfied.

Based on the technical solution, S120 may include: a minimum transmission bandwidth needed for the plurality of video streams which have been frame dropped to a maximum extent is determined. In response to the target estimated bandwidth being less than the minimum transmission bandwidth, the state degradation sequence corresponding to the plurality of video streams is determined based on the stream attribute information of each video stream. In response to the target estimated bandwidth being greater than or equal to the minimum transmission bandwidth, the frame drop process is performed on the plurality of video streams based on the stream attribute information of each video stream and the target estimated bandwidth, and corresponding frame-dropped video streams are transmitted at the current transmission resolution of each video stream.

Specifically, in addition to the resolution degradation, the transmission bandwidth may also be reduced through frame drop. A priority for the frame drop is greater than a priority of the resolution degradation, that is, the transmission bandwidth is reduced through the frame drop preferentially, and the transmission bandwidth is then reduced through the resolution degradation when the frame drop does not satisfy the transmission requirement for the bandwidth. After network congestion occurs, the minimum transmission bandwidth needed for the plurality of video streams which have been frame dropped to the maximum extent can be determined. For example, based on an estimated transmission bitrate and a number of coding layers corresponding to the current transmission resolution of the video stream of which a frame is droppable in the plurality of video streams, a minimum transmission bitrate of the video stream of which a frame is droppable and which has been frame dropped to the maximum extent is determined. For example, in response to determining that the number of coding layers of the video stream of which a frame is droppable is two layers of SVC, the minimum transmission bitrate of the video stream of which a frame is droppable is ½ of the estimated transmission bitrate. In response to determining that the number of coding layers of the video stream of which a frame is droppable is three layers of SVC, the minimum transmission bitrate of the video stream of which a frame is droppable is ⅖ of the estimated transmission bitrate. Minimum transmission bitrates of all video streams of which a frame is droppable are added, and an addition result is determined as the minimum transmission bandwidth needed for the plurality of video streams which have been frame dropped to the maximum extent.

In response to the target estimated bandwidth being less than the minimum transmission bandwidth, it indicates that the transmission requirement for the bandwidth cannot be satisfied through the frame drop. In this case, the resolution-degraded bandwidth allocation process is performed by determining the state degradation sequence and by performing S130 and S140. In response to the target estimated bandwidth being greater than or equal to the minimum transmission bandwidth, it indicates that transmission requirement for the bandwidth may be satisfied through the frame drop. In this case, a frame drop order corresponding to the plurality of video streams may be dynamically determined based on the stream attribute information of each video stream, and the frame drop process is performed on the video streams one-by-one based on the frame drop order until the transmission bandwidth corresponding to all frame-dropped video streams are equal to the target estimated bandwidth. Corresponding frame-dropped video streams are transmitted at the current transmission resolution of each video stream. Thus, bandwidth allocation is performed through the frame drop, the network congestion is alleviated, and the user experience of the real-time communication is further guaranteed.

FIG. 2 is a schematic flowchart of a bandwidth allocation method according to an embodiment of the disclosure. Based on the embodiments disclosed above, this embodiment of the disclosure describes in detail the process of determining the state degradation sequence corresponding to the plurality of video streams. The explanations of terms identical or corresponding to those in the embodiments disclosed above are not repeated herein.

As shown in FIG. 2, the bandwidth allocation method specifically includes the following steps.

At S210, a target estimated bandwidth corresponding to a plurality of video streams is determined.

At S220, an initial resolution state is determined based on the subscription resolution of each video stream.

Specifically, the initial resolution state is obtained by combining the subscription resolution of each video stream. For example, in response to two video streams A and B being existed, and their currently subscribed subscription resolutions are both 180P, the initial resolution state is {180P, 180P}.

At S230, resolution degradation process is performed on the video stream based on the preset stream attribute information of each video stream and the initial resolution state to obtain a resolution state degraded at each time.

Specifically, with the initial resolution state as a start state (that is, a first resolution state), each video stream may be resolution-degraded one-by-one. A new resolution state is obtained after a degradation each time, and only the resolution of one video stream is degraded by one level through the degradation each time. Then traversal of the resolution levels of each video stream is implemented, and all resolution states in which the plurality of video streams can be are further determined.

Exemplary, S230 may include: current degradation priority of each video stream is determined based on the preset stream attribute information of each video stream, and the initial resolution state, and a current target video stream to be degraded is determined based on the current degradation priority. Degradation process is performed on a transmission resolution of the target video stream in the initial resolution state, to determine a second resolution state degraded at a first time. Subsequent degradation process is performed based on the second resolution state until each video stream in a resolution state reaches a lowest resolution.

The current degradation priority may be used to characterize the degradation sequential order of each video stream in the current resolution state (and is the initial resolution state for the degradation at the first time). The target video stream may be a video stream to be degraded in the current resolution state.

Specifically, during the degradation at the first time, the current degradation priority of each video stream may be determined based on the preset stream attribute information of each video stream and the transmission resolution of each video stream in the initial resolution state. For example, in comprehensive consideration of whether each video stream is a shared video stream, whether each video stream is a video stream of an active speaker, whether a frame is droppable and resolution degradable times of the transmission resolution of each video stream in the initial resolution state, the current degradation priority of each video stream is determined. A video stream with highest current degradation priority is determined as the current target video stream to be degraded. The resolution state obtained by reducing the transmission resolution of the target video stream in the initial resolution state by one resolution level is determined as the second resolution state obtained after the degradation at the first time. For example, the initial resolution state is {180P, 180P}, the current target video stream to be degraded is the video stream B, and the second resolution state obtained after the degradation at the first time is {180P, 90P}.

During degradation at a second time, the current degradation priority of each video stream may be determined based on the preset stream attribute information of each video stream and the transmission resolution of each video stream in the second resolution state, and a video stream with highest current degradation priority may be determined as the current target video stream to be degraded. The resolution state obtained by reducing the transmission resolution of the target video stream in the second resolution state by one resolution level is determined as a third resolution state obtained after the degradation at the second time. Similarly, the subsequent resolution states are sequentially determined. In response to each video stream in the determined resolution state being at the lowest resolution, the resolution state is determined as a last resolution state, thus completing resolution degradation on the plurality of video streams.

At S240, the state degradation sequence corresponding to the plurality of video streams is determined based on the initial resolution state, and the resolution state degraded at each time.

Specifically, in degradation sequential order, the initial resolution state, and the resolution state degraded at each time are sequentially ranked, and the state degradation sequence corresponding to the plurality of video streams is obtained, as shown in Table 1.

At S250, resolution-degraded bandwidth allocation process is performed based on the state degradation sequence corresponding to the plurality of video streams, a current transmission resolution of each video stream and the target estimated bandwidth, to determine a degraded target resolution state corresponding to the plurality of video streams.

At S260, the plurality of video streams are transmitted based on a target transmission resolution of each video stream in the target resolution state.

According to the technical solution of the embodiment of the disclosure, the initial resolution state is determined based on the subscription resolution of each video stream, and the resolution state degraded at each time is obtained by performing the resolution degradation on the video stream based on the preset stream attribute information of each video stream and the initial resolution state. The state degradation sequence corresponding to the plurality of video streams can be dynamically determined based on the initial resolution state, and the resolution state degraded at each time. Thus, flexibility and accuracy of the bandwidth allocation are improved.

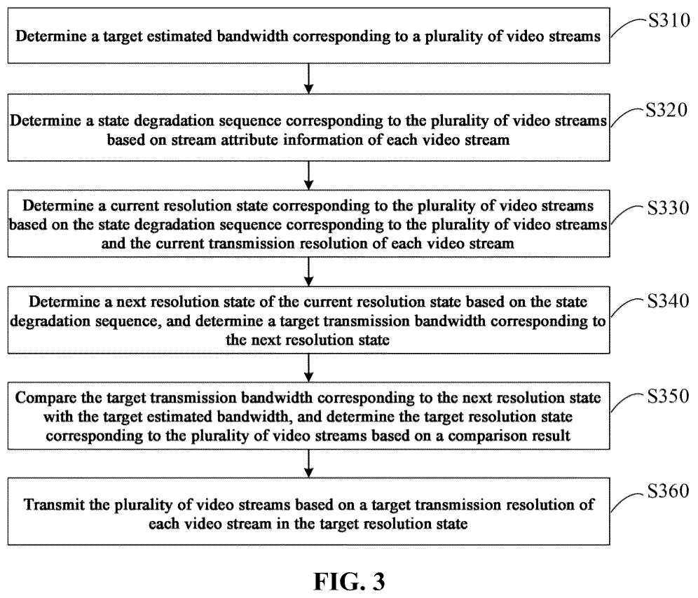

FIG. 3 is a schematic flowchart of a bandwidth allocation method according to an embodiment of the disclosure. Based on the embodiments disclosed above, this embodiment of the disclosure describes in detail the process of the resolution-degraded bandwidth allocation process. The explanations of terms identical or corresponding to those in the embodiments disclosed above are not repeated herein.

As shown in FIG. 3, the bandwidth allocation method specifically includes the following steps.

At S310, a target estimated bandwidth corresponding to a plurality of video streams is determined.

At S320, a state degradation sequence corresponding to the plurality of video streams is determined based on stream attribute information of each video stream.

At S330, a current resolution state corresponding to the plurality of video streams is determined based on the state degradation sequence corresponding to the plurality of video streams and a current transmission resolution of each video stream.

The current resolution state may indicate a resolution state of the plurality of video stream at a current moment. The current resolution state indicates one resolution state in the state degradation sequence. Specifically, based on the current transmission resolution of each video stream, a resolution state with a most matching transmission bandwidth is determined from the state degradation sequence as the current resolution state corresponding to the plurality of video streams.

Exemplary, S330 may include: an actual resolution state corresponding to the plurality of video streams is determined based on the current transmission resolution of each video stream. In response to the actual resolution state existing in the state degradation sequence, the actual resolution state is determined as the current resolution state corresponding to the plurality of video streams. In response to the actual resolution state not existing in the state degradation sequence, an estimated transmission bandwidth corresponding to each resolution state in the state degradation sequence is compared with an actual transmission bandwidth corresponding to the actual resolution state, and the current resolution state corresponding to the plurality of video streams is determined based on a comparison result.

Specifically, the actual resolution state corresponding to the plurality of video streams is obtained by combining the current transmission resolution of each video stream. In response to two video streams A and B being existed, and current transmission resolutions are both 90P, the actual resolution state is determined as {90P, 90P}. The current resolution state corresponding to the plurality of video streams is determined by detecting whether the actual resolution state exists in the state degradation sequence. In response to the actual resolution state being existed, the actual resolution state is directly determined as the current resolution state in the state degradation sequence. In response to the actual resolution state being not existed, an estimated transmission bitrate corresponding to each transmission resolution in each resolution state in the state degradation sequence is determined. The estimated transmission bandwidth corresponding to each resolution state is obtained by adding the estimated transmission bitrates corresponding to the respective transmission resolutions. The actual transmission bandwidth corresponding to the actual resolution state is obtained by adding the actual transmission bitrates corresponding to the respective current transmission resolutions in the actual resolution state. The actual transmission bandwidth is compared with each estimated transmission bandwidth, and the resolution state corresponding to the estimated transmission bandwidth closest to the actual transmission bandwidth is determined as the current resolution state. For example, in response to the actual resolution state {90P, 90P} being not existed in the state degradation sequence, and a bandwidth of the resolution state {180P, 0P} in the sequence is closest to a bandwidth of the actual resolution state {90P, 90P}, the resolution state {180P, 0P} is determined as the current resolution state.

It should be noted that, in response to the stream attribute information being changed in the process of resolution degradation, for example, the subscription resolution is changed, the degradation priority can be affected and changed. Then a new state degradation sequence is needed to be re-determined based on changed stream attribute information, the current resolution state of the plurality of video streams in the new state degradation sequence is re-determined by the above method based on the current transmission resolution of each radio stream, and the resolution degradation process is continuously performed in the new state degradation sequence.

At S340, a next resolution state of the current resolution state is determined based on the state degradation sequence, and a target transmission bandwidth corresponding to the next resolution state is determined.

The next resolution state may indicate the next state adjacent to the current resolution state in the state degradation sequence. For example, in response to the current resolution state being the first resolution state {180P, 180P} in the state degradation sequence 1 given in Table 1 above, the next resolution state is the second resolution state {180P, 90P}. The target transmission bandwidth may indicate a bandwidth required for transmitting the plurality of video streams in the next resolution state.

Specifically, the estimated transmission bitrate corresponding to each transmission resolution may be configured in advance. The estimated transmission bitrates corresponding to the transmission resolutions of the respective video streams in the next resolution state are added, and an obtained addition result is determined as the target transmission bandwidth corresponding to the next resolution state.

Exemplary, the step that “a target transmission bandwidth corresponding to the next resolution state is determined” in S340 may include: the plurality of video streams are transmitted based on a transmission resolution of each video stream in the next resolution state, to obtain an actual transmission bitrate of each video stream. The target transmission bandwidth corresponding to the next resolution state is determined based on the actual transmission bitrate of each video stream.

The actual transmission bitrate may indicate the transmission bitrate actually received by a reception end. Specifically, corresponding video streams are actually transmitted at the transmission resolution of each video stream in the next resolution state, then the actual transmission bitrate of each video stream can be accurately detected, and the target transmission bandwidth corresponding to the next resolution state is obtained by adding the actual transmission bitrates of all video streams together. By actually transmitting the plurality of video streams in the next resolution state, the target transmission bandwidth of the next resolution state can be determined more accurately, and the present target transmission bandwidth is the actual transmission bandwidth, thus further improving accuracy of the resolution degradation.

At S350, the target transmission bandwidth corresponding to the next resolution state is compared with the target estimated bandwidth, and the target resolution state corresponding to the plurality of video streams is determined based on a comparison result.

Specifically, whether the next resolution state is the target resolution state can be quickly and accurately determined by comparing the target transmission bandwidth with the target estimated bandwidth.

Exemplary, the step that “the target resolution state corresponding to the plurality of video streams is determined based on a comparison result” in S350 may include: in response to the target transmission bandwidth corresponding to the next resolution state being equal to or less than the target estimated bandwidth, the next resolution state is determined as the target resolution state corresponding to the plurality of video streams. In response to the target transmission bandwidth corresponding to the next resolution state being greater than the target estimated bandwidth, by taking the next resolution state as the current resolution state, S340 is re-performed.

Specifically, since the resolution degradation is sequentially performed based on the state degradation sequence, and the transmission bandwidth corresponding to each resolution state in the state degradation sequence is sequentially degraded. Then, in response to the target transmission bandwidth corresponding to the next resolution state being equal to or less than the target estimated bandwidth, the next resolution state may be directly determined as the target resolution state corresponding to the plurality of video streams. The target transmission bandwidth corresponding to the next resolution state being greater than the target estimated bandwidth indicates that the next resolution state does not satisfy the transmission requirement for the bandwidth. In this case, by taking the next resolution state as the current resolution state, S340 may be re-performed, such that whether the subsequent resolution states are the target resolution state can be detected one-by-one by cyclically performing S340-S350. For example, in response to the target transmission bandwidth corresponding to a third resolution state {90P, 90P} in Table 1 being equal to or less than the target estimated bandwidth, the target resolution state is determined as {90P, 90P}, and the resolution-degraded bandwidth allocation process is completed.

At S360, the plurality of video streams are transmitted based on a target transmission resolution of each video stream in the target resolution state.

Exemplary, in response to the network being detected to get stronger in the process of transmitting the plurality of video streams, resolution upgradation process may be triggered based on a target estimated bandwidth (greater than the current bandwidth) after the bandwidth is increased. For example, based on the current resolution state of each video stream, a previous resolution state of the current resolution state in the state degradation sequence is determined, and a target transmission bandwidth corresponding to the previous resolution state is determined in the same method as above. In response to the target transmission bandwidth corresponding to the previous resolution state being less than or equal to the target estimated bandwidth after the bandwidth is increased, the current resolution state is switched to the previous resolution state. Corresponding video streams are transmitted at a target transmission resolution of each video stream in the previous resolution state. A state may be upgraded one-by-one according to the state degradation sequence until the target transmission bandwidth corresponding to the previous resolution state is greater than the target estimated bandwidth after the bandwidth is increased, thus implementing the resolution upgradation.

According to the technical solution of the embodiment of the disclosure, the current resolution state corresponding to the plurality of video streams is determined based on the state degradation sequence corresponding to the plurality of video streams and the current transmission resolution of each video stream. The next resolution state of the current resolution state is determined based on the state degradation sequence, and the target transmission bandwidth corresponding to the next resolution state is compared with the target estimated bandwidth. The target resolution state corresponding to the plurality of video streams is determined based on the comparison result. Thereby, the resolution is degraded one-by-one, and accuracy of the resolution degradation is improved.

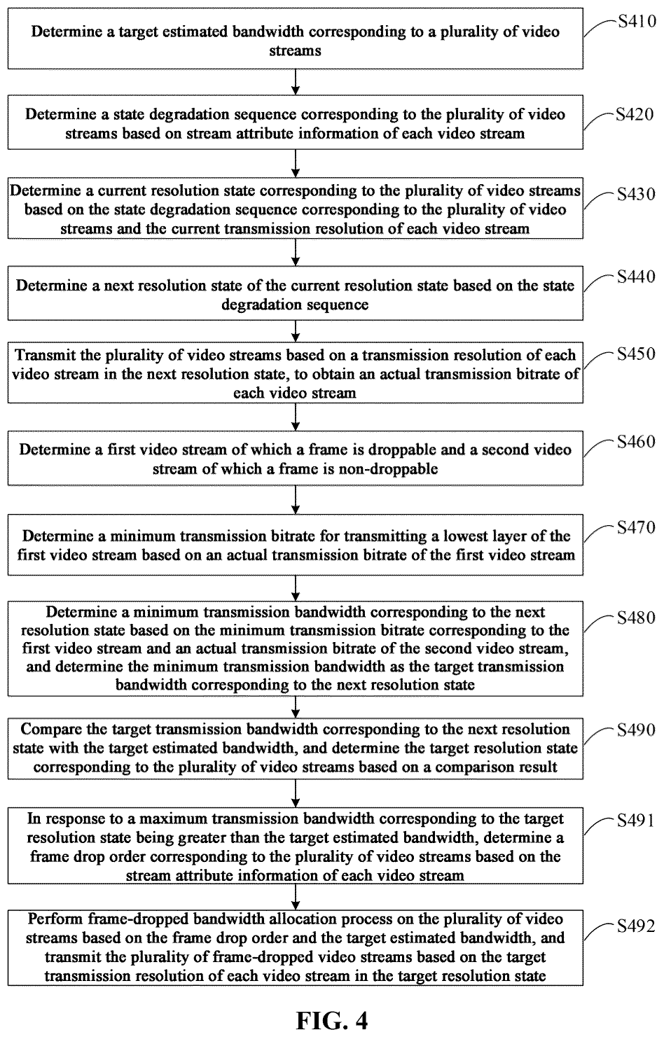

FIG. 4 is a schematic flowchart of a bandwidth allocation method according to an embodiment of the disclosure. Based on the embodiments disclosed above, the step that “the target transmission bandwidth corresponding to the next resolution state is determined based on the actual transmission bitrate of each video stream” is optimized, and the step that “the plurality of video streams are transmitted based on a target transmission resolution of each video stream in the target resolution state” is further optimized on this basis. The explanations of terms identical or corresponding to those in the embodiments disclosed above are not repeated herein.

As shown in FIG. 4, the bandwidth allocation method specifically includes the following steps.

At S410, a target estimated bandwidth corresponding to a plurality of video streams is determined.

At S420, a state degradation sequence corresponding to the plurality of video streams is determined based on stream attribute information of each video stream.

At S430, a current resolution state corresponding to the plurality of video streams is determined based on the state degradation sequence corresponding to the plurality of video streams and a current transmission resolution of each video stream.

At S440, a next resolution state of the current resolution state is determined based on the state degradation sequence.

At S450, the plurality of video streams are transmitted based on a transmission resolution of each video stream in the next resolution state, to obtain an actual transmission bitrate of each video stream.

The actual transmission bitrate may indicate the transmission bitrate actually received by a reception end. Specifically, corresponding video streams are actually transmitted at the transmission resolution of each video stream in the next resolution state, and then the actual transmission bitrate of each video stream can be accurately detected.

At S460, a first video stream of which a frame is droppable and a second video stream of which a frame is non-droppable are determined.

Specifically, whether each video stream is coded based on SVC is determined. The video stream coded based on the SVC is determined as the first video stream of which a frame is droppable. The video stream, which is not coded based on the SVC, is determined as the second video stream of which a frame is non-droppable.

At S470, a minimum transmission bitrate for transmitting a lowest layer of the first video stream is determined based on an actual transmission bitrate of the first video stream.

The minimum transmission bitrate indicates the transmission bitrate of the first video stream which has been frame dropped to the maximum extent. Specifically, based on the actual transmission bitrate of the first video stream, statistics is performed on the transmission bitrate for transmitting the lowest layer T0 of the first video stream, and the transmission bitrate of the T0 layer is determined as the minimum transmission bitrate of the first video stream. For example, in response to a number of coding layers of the first video stream being 2 layers of SVC, a T1 layer may be discarded, and statistics is needed to be performed on the transmission bitrate of the T0 layer. In response to a number of coding layers of the first video stream being 3 layers of SVC, then a T1 layer and a T2 layer may be discarded, and statistics is only needed to be performed on the transmission bitrate of the T0 layer.

At S480, a minimum transmission bandwidth corresponding to the next resolution state is determined based on the minimum transmission bitrate corresponding to the first video stream and an actual transmission bitrate of the second video stream, and the minimum transmission bandwidth is determined as the target transmission bandwidth corresponding to the next resolution state.

Specifically, the target transmission bandwidth corresponding to the next resolution state is obtained by adding the minimum transmission bitrates corresponding to all the first video streams and the actual transmission bitrates of all the second video streams. The present target transmission bandwidth determined is the minimum transmission bandwidth after the frame drop is performed to the maximum extent.

At S490, the target transmission bandwidth corresponding to the next resolution state is compared with the target estimated bandwidth, and the target resolution state corresponding to the plurality of video streams is determined based on a comparison result.

Specifically, the target transmission bandwidth corresponding to the next resolution state being equal to or less than the target estimated bandwidth indicates that the next resolution state may satisfy requirement of the estimated bandwidth, the next resolution state is determined as the target resolution state corresponding to the plurality of video streams. In response to the target transmission bandwidth corresponding to the next resolution state being greater than the target estimated bandwidth, by taking the next resolution state as the current resolution state. S440 is re-performed. The target resolution state satisfying the requirement of the estimated bandwidth is determined by cyclically performing S440-S490.

At S491, in response to a maximum transmission bandwidth corresponding to the target resolution state being greater than the target estimated bandwidth, a frame drop order corresponding to the plurality of video streams is determined based on the stream attribute information of each video stream.

The maximum transmission bandwidth corresponding to the target resolution state may indicate a bandwidth needed to transmit the plurality of video streams in the target resolution state without frame-dropping. The actual transmission bitrates of the video streams in the next resolution state can be directly added together, and an addition result may be taken as the maximum transmission bandwidth corresponding to the target resolution state.

Specifically, whether frame drop is needed is determined by detecting whether the maximum transmission bandwidth corresponding to the target resolution state is greater than the target estimated bandwidth. The maximum transmission bandwidth corresponding to the target resolution state being greater than the target estimated bandwidth indicates that the target estimated bandwidth is between the minimum transmission bandwidth and the maximum transmission bandwidth corresponding to the target resolution state. In this case, frame-dropped bandwidth allocation process and resolution-degraded bandwidth allocation process are needed to be performed simultaneously. In view of that, based on the stream attribute information of each video stream, frame drop priority corresponding to each video stream may be determined, and is ranked in descending order, and a frame drop order corresponding to the plurality of video streams may be obtained. Based on the stream attribute information, the frame drop order corresponding to the plurality of video streams may also be dynamically determined, thus implementing flexible configuration of the frame drop order and satisfying different service demands.

At S492, frame-dropped bandwidth allocation process is performed on the plurality of video streams based on the frame drop order and the target estimated bandwidth, and the plurality of frame-dropped video streams are transmitted based on the target transmission resolution of each video stream in the target resolution state.

Specifically, layer segments in each video stream are sequentially dropped based on the frame drop order until the estimated transmission bandwidth corresponding to the plurality of framed-dropped video streams satisfies the target estimation requirement, for example, the estimated transmission bandwidth is equal to the target estimated bandwidth. The frame-dropped video streams are transmitted at the target transmission resolution of each video stream in the target resolution state, such that a total transmission bandwidth of all the video streams is the target estimated bandwidth or closest to the target estimated bandwidth. Thus, the bandwidth allocation is performed by using the frame drop and the resolution degradation at the same time, and the accuracy and flexibility of the bandwidth allocation are further improved.

Exemplary, the maximum transmission bandwidth corresponding to the target resolution state being equal to or less than the target estimated bandwidth indicates that frame drop is not needed, and corresponding video streams are directly transmitted at the target transmission resolution of each video stream in the target resolution state. Thus, the bandwidth allocation is only performed through the resolution degradation.

According to the technical solution of the embodiment of the disclosure, the minimum transmission bitrate for transmitting the lowest layer of the first video stream is determined based on the actual transmission bitrate of the first video stream of which a frame is droppable. The minimum transmission bandwidth of the next resolution state after the frame drop is performed to the maximum extent is determined based on the minimum transmission bitrate corresponding to the first video stream and the actual transmission bitrate of the second video stream of which a frame is non-droppable. In response to the maximum transmission bandwidth corresponding to the target resolution state being greater than the target estimated bandwidth, the frame-dropped bandwidth allocation process is performed on the plurality of video streams based on the frame drop order corresponding to the plurality of video streams, and the plurality of frame-dropped video streams are transmitted based on the target transmission resolution of each video stream in the target resolution state. Thus, the frame-dropped bandwidth allocation process and the resolution-degraded bandwidth allocation process are performed on the video streams simultaneously, and the effect and flexibility of the bandwidth allocation are further improved.

FIG. 5 is a schematic structural diagram of a bandwidth allocation apparatus according to an embodiment of the disclosure. As shown in FIG. 5, the apparatus specifically includes: a target estimated bandwidth determination module 510, a state degradation sequence determination module 520, a target resolution state determination module 530 and a video stream transmission module 540.

The target estimated bandwidth determination module 510 is configured to determine a target estimated bandwidth corresponding to a plurality of video streams. The state degradation sequence determination module 520 is configured to determine a state degradation sequence corresponding to the plurality of video streams based on stream attribute information of each video stream. The state degradation sequence includes a plurality of resolution states arranged in a degradation order, and each resolution state includes a transmission resolution of each video stream. The target resolution state determination module 530 is configured to perform resolution-degraded bandwidth allocation process based on the state degradation sequence corresponding to the plurality of video streams, a current transmission resolution of each video stream and the target estimated bandwidth, to determine a degraded target resolution state corresponding to the plurality of video streams. The video stream transmission module 540 is configured to transmit the plurality of video streams based on a target transmission resolution of each video stream in the target resolution state.

According to the technical solution of the embodiment of the disclosure, the state degradation sequence corresponding to the plurality of video streams can be dynamically determined based on the stream attribute information of each video stream. The state degradation sequence includes the plurality of resolution states arranged in a degradation order, and each resolution state includes the transmission resolution of each video stream. Different types of stream attribute information can correspond to different resolution degradation orders, the resolution degradation orders are dynamically determined, and the different service demands are further satisfied. The resolution-degraded bandwidth allocation process is performed based on the state degradation sequence corresponding to the plurality of video streams, the current transmission resolution of each video stream and the target estimated bandwidth corresponding to the plurality of video streams, to determine the degraded target resolution state corresponding to the plurality of video streams. The plurality of video streams are transmitted based on the target transmission resolution of each video stream in the target resolution state. Thus, the flexible and effective bandwidth allocation is performed through the resolution degradation, and the transmission requirement for the estimated bandwidth and the different service demands are satisfied.

Based on the technical solution describe above, the stream attribute information of each video stream includes: a subscription resolution and preset stream attribute information, and the preset stream attribute information includes at least one of: whether a video stream being a shared video stream, whether a video stream being a video stream of an active speaker, whether a frame being droppable and resolution degradable times of each transmission resolution.

Based on the technical solutions described above, the state degradation sequence determination module 520 includes: an initial resolution state determination unit, a resolution degradation processing unit and a state degradation sequence determination unit.

The initial resolution state determination unit is configured to determine an initial resolution state based on the subscription resolution of each video stream.

The resolution degradation processing unit is configured to perform resolution degradation process on the video stream based on the preset stream attribute information of each video stream and the initial resolution state to obtain a resolution state degraded at each time.

The state degradation sequence determination unit is configured to determine the state degradation sequence corresponding to the plurality of video streams based on the initial resolution state, and the resolution state degraded at each time.

Based on the technical solutions described above, the resolution degradation processing unit is specifically configured to: determine current degradation priority of each video stream based on the preset stream attribute information of each video stream, and the initial resolution state, and determine, based on the current degradation priority, a current target video stream to be degraded; performing degradation process on a transmission resolution of the target video stream in the initial resolution state, to determine a second resolution state degraded at a first time; and perform subsequent degradation process based on the second resolution state until each video stream in a resolution state reaches a lowest resolution.

Based on the technical solutions described above, the target resolution state determination module 530 includes: a current resolution state determination unit, a target transmission bandwidth determination unit and a target resolution state determination unit.

The current resolution state determination unit is configured to determine a current resolution state corresponding to the plurality of video streams based on the state degradation sequence corresponding to the plurality of video streams and the current transmission resolution of each video stream.

The target transmission bandwidth determination unit is configured to determine a next resolution state of the current resolution state based on the state degradation sequence, and determine a target transmission bandwidth corresponding to the next resolution state.

The target resolution state determination unit is configured to compare the target transmission bandwidth corresponding to the next resolution state with the target estimated bandwidth, and determine the target resolution state corresponding to the plurality of video streams based on a comparison result.

Based on the technical solutions described above, the current resolution state determination unit is specifically configured to: determine an actual resolution state corresponding to the plurality of video streams based on the current transmission resolution of each video stream; in response to the actual resolution state existing in the state degradation sequence, determine the actual resolution state as the current resolution state corresponding to the plurality of video streams; and in response to the actual resolution state not existing in the state degradation sequence, compare an estimated transmission bandwidth corresponding to each resolution state in the state degradation sequence with an actual transmission bandwidth corresponding to the actual resolution state, and determine the current resolution state corresponding to the plurality of video streams based on a comparison result.

Based on the technical solutions described above, the target transmission bandwidth determination unit includes: an actual transmission bitrate determination sub-unit, and a target transmission bandwidth determination sub-unit.

The actual transmission bitrate determination sub-unit is configured to transmit the plurality of video streams based on a transmission resolution of each video stream in the next resolution state, to obtain an actual transmission bitrate of each video stream.

The target transmission bandwidth determination sub-unit is configured to determine the target transmission bandwidth corresponding to the next resolution state based on the actual transmission bitrate of each video stream.

Based on the technical solutions described above, the target resolution state determination unit is specifically configured to: in response to the target transmission bandwidth corresponding to the next resolution state being equal to or less than the target estimated bandwidth, determine the next resolution state as the target resolution state corresponding to the plurality of video streams; and in response to the target transmission bandwidth corresponding to the next resolution state being greater than the target estimated bandwidth, re-perform, by taking the next resolution state as the current resolution state, the step of determining the next resolution state of the current resolution state based on the state degradation sequence.

Based on the technical solutions described above, the target transmission bandwidth determination sub-unit is specifically configured to: determine a first video stream of which a frame is droppable and a second video stream of which a frame is non-droppable; determine a minimum transmission bitrate for transmitting a lowest layer of the first video stream based on an actual transmission bitrate of the first video stream; and determine a minimum transmission bandwidth corresponding to the next resolution state based on the minimum transmission bitrate corresponding to the first video stream and an actual transmission bitrate of the second video stream, and determine the minimum transmission bandwidth as the target transmission bandwidth corresponding to the next resolution state.

Based on the technical solutions described above, the video stream transmission module 540 is specifically configured to: in response to a maximum transmission bandwidth corresponding to the target resolution state being greater than the target estimated bandwidth, determine a frame drop order corresponding to the plurality of video streams based on the stream attribute information of each video stream; and perform frame-dropped bandwidth allocation process on the plurality of video streams based on the frame drop order and the target estimated bandwidth, and transmit the plurality of frame-dropped video streams based on the target transmission resolution of each video stream in the target resolution state.

The bandwidth allocation apparatus according to the embodiment of the disclosure may perform the bandwidth allocation method according to any embodiment of the disclosure, and has corresponding functional modules and beneficial effects for performing the bandwidth allocation method.

It is worth noting that the units and modules included in the apparatus described above are only divided according to a functional logic, but are not limited to the above division, as long as the corresponding functions can be performed. In addition, specific names of the functional unit are only for the convenience of mutual distinguishing rather than limitation to the protection scope of the embodiment of the disclosure.

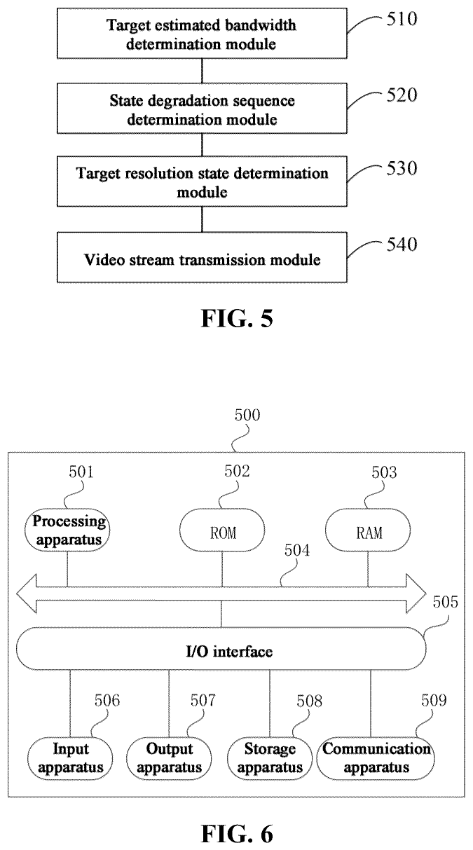

FIG. 6 is a schematic structural diagram of an electronic device according to an embodiment of the disclosure. With reference to FIG. 6, a schematic structural diagram of the electronic device 500 (for example, a terminal device or a server in FIG. 6) applied to implementation of the embodiment of the disclosure is shown. The terminal device in the embodiment of the disclosure may include, but is not limited to, a mobile terminal such as a mobile phone, a notebook computer, a digital broadcast receiver, a personal digital assistant (PDA), a portable android device (PAD), a portable multimedia player (PMP), and a vehicle-mounted terminal (such as a vehicle-mounted navigation terminal), and a fixed terminal such as a digital TV and a desktop computer. The electronic device shown in FIG. 6 is only an example, and should not be constructed as limitation to functions and application scopes of the embodiment of the disclosure.

As shown in FIG. 6, the electronic device 500 may include a processing apparatus 501 (for example, a central processing unit and a graphics processing unit), which may execute various appropriate actions and processing according to a program stored in a read-only memory (ROM) 502 or loaded from a storage apparatus 508 to a random access memory (RAM) 503. The RAM 503 may further store various programs and data required for the operation by the electronic device 500. The processing apparatus 501, the ROM 502, and the RAM 503 are connected to one another through a bus 504. An edit/output (I/O) interface 505 is also connected to the bus 504.

Generally, the following apparatuses may be connected to the I/O interface 505: an input apparatus 506 including, for example, a touch screen, a touch pad, a keyboard, a mouse, a camera, a microphone, an accelerometer and a gyroscope; an output apparatus 507 including, for example, a liquid crystal display (LCD), a speaker and a vibrator; the storage apparatus 508 including, for example, a magnetic tape and a hard disk; and a communication apparatus 509. The communication apparatus 509 may allow the electronic device 500 to be in wireless or wired communication with other devices for data exchange. Although the electronic device 500 having various apparatuses is shown in FIG. 6, it should be understood that all the apparatuses shown are not required to be implemented or provided. More or fewer apparatuses may be alternatively implemented or provided.

Specifically, according to the embodiment of the disclosure, a process described above with reference to the flowchart may be implemented as a computer software program. For example, the embodiment of the disclosure includes a computer program product. The computer program product includes a computer program carried on a non-transient computer-readable medium, and the computer program includes program codes for performing the method shown in the flowchart. In such an embodiment, the computer program may be downloaded and installed from the network through the communication apparatus 509, or installed from the storage apparatus 508, or installed from the ROM 502. When executed by the processing apparatus 501, the computer program executes the above functions defined in the method of the embodiment of the disclosure.

A name of messages or information exchanged among a plurality of apparatuses in the embodiment of the disclosure is only used for illustration rather than limitation to the scope of these messages or information.

The electronic device according to the embodiment of the disclosure belongs to the same inventive concept as the bandwidth allocation method according to the above embodiment, reference can be made to the embodiment described above for the technical details not described in detail in this embodiment, and this embodiment has the same beneficial effects as the embodiment described above.

The embodiment of the disclosure provides a computer storage medium. The computer storage medium stores a computer program. The computer program implements the bandwidth allocation method according to the embodiment described above when executed by a processor.

It should be noted that the computer-readable medium described above in the disclosure may be a computer-readable signal medium or a computer-readable storage medium or their any combination. For example, the computer-readable storage medium may be, but are not limited to, an electric, magnetic, optical, electromagnetic, infrared, or semiconductor system, apparatus or device, or their any combination. More specific examples of the computer-readable storage medium may include, but is not limited to, an electrical connection having one or more wires, a portable computer disk, a hard disk, a random access memory (RAM), a read-only memory (ROM), an erasable programmable read-only memory (EPROM) or a flash memory, an optical fiber, a portable compact disk read-only memory (CD-ROM), an optical storage device, a magnetic storage device, or their any suitable combination. In the disclosure, the computer-readable storage medium may be any tangible medium including or storing a program, and the program may be used by or in combination with an instruction execution system, apparatus or device. In the disclosure, the computer-readable signal medium may include a data signal propagated in a baseband or as part of a carrier wave, in which a computer-readable program code is carried. This propagated data signal may have a plurality of forms, including but not limited to an electromagnetic signal, an optical signal or their any suitable combination. The computer-readable signal medium may further be any computer-readable medium other than the computer-readable storage medium, and the computer-readable signal medium may send, propagate or transmit a program used by or in combination with the instruction execution system, apparatus or device. A program code included in the computer-readable medium may be transmitted by any suitable medium, including but not limited to: a wire, an optical cable, a radio frequency (RF) medium, etc., or their any suitable combination.

In some embodiments, a client side and a server may communicate by using any currently-known or future-developed network protocol such as the hypertext transfer protocol (HTTP), and may be interconnected to digital data communication (for example, a communication network) in any form or medium. Examples of the communication network include a local area network (“LAN”), a wide area network (“WAN”), internet work (for example, the Internet), an end-to-end network (for example, adhoc end-to-end network), and any currently-known or future-developed network.

The computer-readable medium may be included in the electronic device, or exist independently without being fitted into the electronic device.

The computer-readable medium carries one or more programs. When executed by the electronic device, the one or more programs cause the electronic device to: determine a target estimated bandwidth corresponding to a plurality of video streams; determine a state degradation sequence corresponding to the plurality of video streams based on stream attribute information of each video stream, the state degradation sequence including a plurality of resolution states arranged in a degradation order, and each resolution state including a transmission resolution of each video stream; perform resolution-degraded bandwidth allocation process based on the state degradation sequence corresponding to the plurality of video streams, a current transmission resolution of each video stream and the target estimated bandwidth, to determine a degraded target resolution state corresponding to the plurality of video streams; and transmit the plurality of video streams based on the target transmission resolution of each video stream in the target resolution state.

Computer program codes for performing the operations of the disclosure may be written in one or more programming languages or their combinations, and the programming languages include, but are not limited to, object-oriented programming languages such as Java, Smalltalk and C++, and further include conventional procedural programming languages such as “C” language or similar programming languages. The program codes may be completely executed on a computer of the user, partially executed on the computer of the user, executed as an independent software package, partially executed on the computer of the user and a remote computer separately, or completely executed on the remote computer or the server. In the case of involving the remote computer, the remote computer may be connected to the computer of the user through any type of network, including a local area network (LAN) or a wide area network (WAN), or may be connected to an external computer (for example, through the Internet provided by an Internet service provider).

The flowcharts and block diagrams in the accompanying drawings illustrate the architectures, functions and operations that may be implemented by the systems, the methods and the computer program products according to various embodiments of the disclosure. In this regard, each block in the flowchart or block diagram may represent one module, one program segment, or some of codes that includes one or more executable instructions for implementing specified logical functions. It should also be noted that in some alternative implementations, the functions indicated in the blocks may occur in an order different than those indicated in the accompanying drawings. For example, two blocks indicated in succession may actually be executed in substantially parallel, and may sometimes be executed in a reverse order depending on the functions involved. It should also be noted that each block in the block diagram and/or flowchart, and a combination of blocks in the block diagram and/or flowchart may be implemented by a specific hardware-based system that executes specified functions or operations, or may be implemented by a combination of specific hardware and computer instructions.

The units involved in the embodiment of the disclosure may be implemented by software or hardware. A name of the unit does not constitute limitation to the unit itself in some cases. For example, a first obtainment unit may also be described as “a unit that obtains at least two Internet protocol addresses”.

The functions described above herein may be executed at least in part by one or more hardware logic components. For example, in a non-limitative mode, illustrative types of hardware logic components that may be used include: a field programmable gate array (FPGA), an application specific integrated circuit (ASIC), an application specific standard product (ASSP), a system on chip (SOC), a complex programmable logic device (CPLD), etc.

In the context of the disclosure, a machine-readable medium may be a tangible medium, and may include or store a program that is used by or in combination with the instruction execution system, apparatus or device. The machine-readable medium may be a machine-readable signal medium or a machine-readable storage medium. The machine-readable medium may include, but is not limited to, an electric, magnetic, optical, electromagnetic, infrared, or semiconductor system, apparatus or device, or their any suitable combination. More specific examples of the machine-readable storage medium may include an electrical connection based on one or more wires, a portable computer disk, a hard disk, a random access memory (RAM), a read-only memory (ROM), an erasable programmable read-only memory (EPROM) or a flash memory, an optical fiber, a portable compact disk read-only memory (CD-ROM), an optical storage device, a magnetic storage device, or their any suitable combination.

According to one or more embodiments of the disclosure, [Example 1] provides a bandwidth allocation method. The method includes: determining a target estimated bandwidth corresponding to a plurality of video streams; determining a state degradation sequence corresponding to the plurality of video streams based on stream attribute information of each video stream, the state degradation sequence including a plurality of resolution states arranged in a degradation order, and each resolution state including a transmission resolution of each video stream: performing resolution-degraded bandwidth allocation process based on the state degradation sequence corresponding to the plurality of video streams, a current transmission resolution of each video stream, and the target estimated bandwidth, to determine a degraded target resolution state corresponding to the plurality of video streams; and transmitting the plurality of video streams based on a target transmission resolution of each video stream in the target resolution state.

According to one or more embodiments of the disclosure, [Example 2] provides the bandwidth allocation method. The method further includes that: optionally, the stream attribute information of each video stream includes: a subscription resolution and preset stream attribute information, and the preset stream attribute information includes at least one of: whether a video stream being a shared video stream, whether a video stream being a video stream of an active speaker, whether a frame being droppable and resolution degradable times of each transmission resolution.

According to one or more embodiments of the disclosure, [Example 3] provides the bandwidth allocation method. The method further includes that: optionally, determining the state degradation sequence corresponding to the plurality of video streams based on the stream attribute information of each video stream includes: determining an initial resolution state based on the subscription resolution of each video stream: performing resolution degradation process on the video stream based on the preset stream attribute information of each video stream and the initial resolution state to obtain a resolution state degraded at each time; and determining the state degradation sequence corresponding to the plurality of video streams based on the initial resolution state and the resolution state degraded at each time.

According to one or more embodiments of the disclosure, [Example 4] provides the bandwidth allocation method. The method further includes that: optionally, performing the resolution degradation process on the video stream based on the preset stream attribute information of each video stream and the initial resolution state to obtain the resolution state degraded at each time includes: determining current degradation priority of each video stream based on the preset stream attribute information of each video stream and the initial resolution state, and determining, based on the current degradation priority, a current target video stream to be degraded: performing degradation process on a transmission resolution of the target video stream in the initial resolution state, to determine a second resolution state degraded at a first time; and performing subsequent degradation process based on the second resolution state until each video stream in a resolution state reaches a lowest resolution.

According to one or more embodiments of the disclosure, [Example 5] provides the bandwidth allocation method. The method further includes that: optionally, performing the resolution-degraded bandwidth allocation process based on the state degradation sequence corresponding to the plurality of video streams, the current transmission resolution of each video stream and the target estimated bandwidth, to determine the degraded target resolution state corresponding to the plurality of video streams includes: determining a current resolution state corresponding to the plurality of video streams based on the state degradation sequence corresponding to the plurality of video streams and the current transmission resolution of each video stream; determining a next resolution state of the current resolution state based on the state degradation sequence, and determining a target transmission bandwidth corresponding to the next resolution state; and comparing the target transmission bandwidth corresponding to the next resolution state with the target estimated bandwidth, and determining the target resolution state corresponding to the plurality of video streams based on a comparison result.

According to one or more embodiments of the disclosure, [Example 6] provides the bandwidth allocation method. The method further includes that: optionally, determining the current resolution state corresponding to the plurality of video streams based on the state degradation sequence corresponding to the plurality of video streams and the current transmission resolution of each video stream includes: determining an actual resolution state corresponding to the plurality of video streams based on the current transmission resolution of each video stream: in response to the actual resolution state existing in the state degradation sequence, determining the actual resolution state as the current resolution state corresponding to the plurality of video streams; and in response to the actual resolution state not existing in the state degradation sequence, comparing an estimated transmission bandwidth corresponding to each resolution state in the state degradation sequence with an actual transmission bandwidth corresponding to the actual resolution state, and determining the current resolution state corresponding to the plurality of video streams based on a comparison result.

According to one or more embodiments of the disclosure, [Example 7] provides the bandwidth allocation method. The method further includes that: optionally, determining the target transmission bandwidth corresponding to the next resolution state includes: transmitting the plurality of video streams based on a transmission resolution of each video stream in the next resolution state, to obtain an actual transmission bitrate of each video stream; and determining the target transmission bandwidth corresponding to the next resolution state based on the actual transmission bitrate of each video stream.

According to one or more embodiments of the disclosure, [Example 8] provides the bandwidth allocation method. The method further includes that: optionally, determining the target resolution state corresponding to the plurality of video streams based on the comparison result includes: in response to the target transmission bandwidth corresponding to the next resolution state being equal to or less than the target estimated bandwidth, determining the next resolution state as the target resolution state corresponding to the plurality of video streams; and in response to the target transmission bandwidth corresponding to the next resolution state being greater than the target estimated bandwidth, re-performing, by taking the next resolution state as the current resolution state, the step of determining the next resolution state of the current resolution state based on the state degradation sequence.

According to one or more embodiments of the disclosure, [Example 9] provides the bandwidth allocation method. The method further includes that: optionally, determining the target transmission bandwidth corresponding to the next resolution state based on the actual transmission bitrate of each video stream includes: determining a first video stream of which a frame is droppable and a second video stream of which a frame is non-droppable; determining a minimum transmission bitrate for transmitting a lowest layer of the first video stream based on an actual transmission bitrate of the first video stream; and determining a minimum transmission bandwidth corresponding to the next resolution state based on the minimum transmission bitrate corresponding to the first video stream and an actual transmission bitrate of the second video stream, and determining the minimum transmission bandwidth as the target transmission bandwidth corresponding to the next resolution state.

According to one or more embodiments of the disclosure, [Example 10] provides the bandwidth allocation method. The method further includes that: optionally, transmitting the plurality of video streams based on the target transmission resolution of each video stream in the target resolution state includes: in response to a maximum transmission bandwidth corresponding to the target resolution state being greater than the target estimated bandwidth, determining a frame drop order corresponding to the plurality of video streams based on the stream attribute information of each video stream; and performing frame-dropped bandwidth allocation process on the plurality of video streams based on the frame drop order and the target estimated bandwidth, and transmitting the plurality of frame-dropped video streams based on the target transmission resolution of each video stream in the target resolution state.

According to one or more embodiments of the disclosure, [Example 11] provides a bandwidth allocation apparatus. The apparatus includes: a target estimated bandwidth determination module configured to determine a target estimated bandwidth corresponding to a plurality of video streams: a state degradation sequence determination module configured to determine a state degradation sequence corresponding to the plurality of video streams based on stream attribute information of each video stream, the state degradation sequence including a plurality of resolution states arranged in a degradation order, and each resolution state including a transmission resolution of each video stream: a target resolution state determination module configured to perform resolution-degraded bandwidth allocation process based on the state degradation sequence corresponding to the plurality of video streams, a current transmission resolution of each video stream and the target estimated bandwidth, to determine a degraded target resolution state corresponding to the plurality of video streams; and a video stream transmission module configured to transmit the plurality of video streams based on a target transmission resolution of each video stream in the target resolution state.

What is described above is only description of preferred embodiments of the disclosure and applied technical principles. It should be understood by those skilled in the art that the disclosed scope involved in the disclosure is not limited to the technical solution formed by a specific combination of the technical features described above, but further covers other technical solution formed by any random combination of the technical features described above or their equivalent features without departing from the concepts described above of the disclosure, for example, a technical solution formed by interchanging the features described above and (non-limitative) technical features having similar functions as disclosed in the disclosure.

In addition, although the operations are depicted in a particular order, it should not be understood that these operations are required to be executed in the particular order shown or in a sequential order. In certain circumstances, multi-task and parallel processing can be advantageous. Similarly, although several specific implementation details are included in the discussion described above, these details should not be construed as limitation to the scope of the disclosure. Some features described in the context of a separate embodiment can be further implemented in a single embodiment in a combination manner. On the contrary, various features described in the context of a single embodiment can be further implemented in a plurality of embodiments separately or in any suitable sub-combination manner.

Although the subject matter has been described in a language specific to structural features and/or methodological logical actions, it should be understood that the subject matter defined in the appended claims is not necessarily limited to the specific features or actions described above. On the contrary, the specific features and actions described above are only illustrative implementation forms of the claims.

I/We claim:

1. A bandwidth allocation method, comprising:
determining a target estimated bandwidth corresponding to a plurality of video streams;
determining a state degradation sequence corresponding to the plurality of video streams based on stream attribute information of each video stream, the state degradation sequence comprising a plurality of resolution states arranged in a degradation order, and each resolution state comprising a transmission resolution of each video stream;
performing resolution-degraded bandwidth allocation process based on the state degradation sequence corresponding to the plurality of video streams, a current transmission resolution of each video stream, and the target estimated bandwidth, to determine a degraded target resolution state corresponding to the plurality of video streams; and
transmitting the plurality of video streams based on a target transmission resolution of each video stream in the target resolution state.

2. The bandwidth allocation method according to claim 1, wherein the stream attribute information of each video stream comprises: a subscription resolution and preset stream attribute information, and the preset stream attribute information comprises at least one of:
whether a video stream is a shared video stream, whether the video stream is of an active speaker, whether a frame is droppable, and resolution degradable times of each transmission resolution.

3. The bandwidth allocation method according to claim 2, wherein determining the state degradation sequence corresponding to the plurality of video streams based on the stream attribute information of each video stream comprises:
determining an initial resolution state based on the subscription resolution of each video stream;
performing resolution degradation process on the video stream based on the preset stream attribute information of each video stream and the initial resolution state to obtain a resolution state degraded at each time; and
determining the state degradation sequence corresponding to the plurality of video streams based on the initial resolution state and the resolution state degraded at each time.

4. The bandwidth allocation method according to claim 3, wherein performing the resolution degradation process on the video stream based on the preset stream attribute information of each video stream and the initial resolution state to obtain the resolution state degraded at each time comprises:
determining current degradation priority of each video stream based on the preset stream attribute information of each video stream and the initial resolution state, and determining, based on the current degradation priority, a current target video stream to be degraded;
performing degradation process on a transmission resolution of the current target video stream in the initial resolution state, to determine a second resolution state degraded at a first time; and
performing subsequent degradation process based on the second resolution state until each video stream in a resolution state reaches a lowest resolution.

5. The bandwidth allocation method according to claim 1, wherein performing the resolution-degraded bandwidth allocation process based on the state degradation sequence corresponding to the plurality of video streams, the current transmission resolution of each video stream and the target estimated bandwidth, to determine the degraded target resolution state corresponding to the plurality of video streams comprises:
determining a current resolution state corresponding to the plurality of video streams based on the state degradation sequence corresponding to the plurality of video streams and the current transmission resolution of each video stream;
determining a next resolution state of the current resolution state based on the state degradation sequence, and determining a target transmission bandwidth corresponding to the next resolution state; and
comparing the target transmission bandwidth corresponding to the next resolution state with the target estimated bandwidth, and determining the target resolution state corresponding to the plurality of video streams based on a comparison result.

6. The bandwidth allocation method according to claim 5, wherein determining the current resolution state corresponding to the plurality of video streams based on the state degradation sequence corresponding to the plurality of video streams and the current transmission resolution of each video stream comprises:
determining an actual resolution state corresponding to the plurality of video streams based on the current transmission resolution of each video stream;
in response to the actual resolution state existing in the state degradation sequence, determining the actual resolution state as the current resolution state corresponding to the plurality of video streams; and
in response to the actual resolution state not existing in the state degradation sequence, comparing an estimated transmission bandwidth corresponding to each resolution state in the state degradation sequence with an actual transmission bandwidth corresponding to the actual resolution state, and determining the current resolution state corresponding to the plurality of video streams based on a comparison result.

7. The bandwidth allocation method according to claim 5, wherein determining the target transmission bandwidth corresponding to the next resolution state comprises:
transmitting the plurality of video streams based on a transmission resolution of each video stream in the next resolution state, to obtain an actual transmission bitrate of each video stream; and
determining the target transmission bandwidth corresponding to the next resolution state based on the actual transmission bitrate of each video stream.

8. The bandwidth allocation method according to claim 5, wherein determining the target resolution state corresponding to the plurality of video streams based on the comparison result comprises:
in response to the target transmission bandwidth corresponding to the next resolution state being equal to or less than the target estimated bandwidth, determining the next resolution state as the target resolution state corresponding to the plurality of video streams; and
in response to the target transmission bandwidth corresponding to the next resolution state being greater than the target estimated bandwidth, re-performing, by taking the next resolution state as the current resolution state, the determining the next resolution state of the current resolution state based on the state degradation sequence.

9. The bandwidth allocation method according to claim 7, wherein determining the target transmission bandwidth corresponding to the next resolution state based on the actual transmission bitrate of each video stream comprises:
determining a first video stream of which a frame is droppable and a second video stream of which a frame is non-droppable;
determining a minimum transmission bitrate for transmitting a lowest layer of the first video stream based on an actual transmission bitrate of the first video stream; and
determining a minimum transmission bandwidth corresponding to the next resolution state based on the minimum transmission bitrate corresponding to the first video stream and an actual transmission bitrate of the second video stream, and determining the minimum transmission bandwidth as the target transmission bandwidth corresponding to the next resolution state.

10. The bandwidth allocation method according to claim 9, wherein transmitting the plurality of video streams based on the target transmission resolution of each video stream in the target resolution state comprises:
in response to a maximum transmission bandwidth corresponding to the target resolution state being greater than the target estimated bandwidth, determining a frame drop order corresponding to the plurality of video streams based on the stream attribute information of each video stream; and
performing frame-dropped bandwidth allocation process on the plurality of video streams based on the frame drop order and the target estimated bandwidth, and transmitting the plurality of frame-dropped video streams based on the target transmission resolution of each video stream in the target resolution state.

11. An electronic device, comprising:
one or more processors; and
a storage configured to store one or more programs which, when executed by the one or more processors, configure the one or more processors to;
determine a target estimated bandwidth corresponding to a plurality of video streams:
determine a state degradation sequence corresponding to the plurality of video streams based on stream attribute information of each video stream, the state degradation sequence comprising a plurality of resolution states arranged in a degradation order, and each resolution state comprising a transmission resolution of each video stream;
perform resolution-degraded bandwidth allocation process based on the state degradation sequence corresponding to the plurality of video streams, a current transmission resolution of each video stream, and the target estimated bandwidth, to determine a degraded target resolution state corresponding to the plurality of video streams; and
transmit the plurality of video streams based on a target transmission resolution of each video stream in the target resolution state.

12. The electronic device according to claim 11, wherein the stream attribute information of each video stream comprises: a subscription resolution and preset stream attribute information, and the preset stream attribute information comprises at least one of:
whether a video stream is a shared video stream, whether the video stream is of an active speaker, whether a frame is droppable, and resolution degradable times of each transmission resolution.

13. The electronic device according to claim 12, wherein to determine the state degradation sequence corresponding to the plurality of video streams based on the stream attribute information of each video stream, the one or more processors is configured to:
determine an initial resolution state based on the subscription resolution of each video stream:
perform resolution degradation process on the video stream based on the preset stream attribute information of each video stream and the initial resolution state to obtain a resolution state degraded at each time; and
determine the state degradation sequence corresponding to the plurality of video streams based on the initial resolution state and the resolution state degraded at each time.

14. The electronic device according to claim 13, wherein to perform the resolution degradation process on the video stream based on the preset stream attribute information of each video stream and the initial resolution state to obtain the resolution state degraded at each time, the one or more processors is configured to:
determine current degradation priority of each video stream based on the preset stream attribute information of each video stream and the initial resolution state, and determine, based on the current degradation priority; a current target video stream to be degraded;
perform degradation process on a transmission resolution of the current target video stream in the initial resolution state, to determine a second resolution state degraded at a first time; and
perform subsequent degradation process based on the second resolution state until each video stream in a resolution state reaches a lowest resolution.

15. The electronic device according to claim 11, wherein to perform the resolution-degraded bandwidth allocation process based on the state degradation sequence corresponding to the plurality of video streams, the current transmission resolution of each video stream and the target estimated bandwidth, to determine the degraded target resolution state corresponding to the plurality of video streams, the one or more processors is configured to:
determine a current resolution state corresponding to the plurality of video streams based on the state degradation sequence corresponding to the plurality of video streams and the current transmission resolution of each video stream;
determine a next resolution state of the current resolution state based on the state degradation sequence, and determine a target transmission bandwidth corresponding to the next resolution state; and
compare the target transmission bandwidth corresponding to the next resolution state with the target estimated bandwidth, and determine the target resolution state corresponding to the plurality of video streams based on a comparison result.

16. The electronic device according to claim 15, wherein to determine the current resolution state corresponding to the plurality of video streams based on the state degradation sequence corresponding to the plurality of video streams and the current transmission resolution of each video stream, the one or more processors is configured to:
determine an actual resolution state corresponding to the plurality of video streams based on the current transmission resolution of each video stream;
in response to the actual resolution state existing in the state degradation sequence, determine the actual resolution state as the current resolution state corresponding to the plurality of video streams; and
in response to the actual resolution state not existing in the state degradation sequence, compare an estimated transmission bandwidth corresponding to each resolution state in the state degradation sequence with an actual transmission bandwidth corresponding to the actual resolution state, and determine the current resolution state corresponding to the plurality of video streams based on a comparison result.

17. The electronic device according to claim 15, wherein to determine the target transmission bandwidth corresponding to the next resolution state, the one or more processors is configured to:
transmit the plurality of video streams based on a transmission resolution of each video stream in the next resolution state, to obtain an actual transmission bitrate of each video stream; and
determine the target transmission bandwidth corresponding to the next resolution state based on the actual transmission bitrate of each video stream.

18. The electronic device according to claim 15, wherein to determine the target resolution state corresponding to the plurality of video streams based on the comparison result, the one or more processors is configured:
in response to the target transmission bandwidth corresponding to the next resolution state being equal to or less than the target estimated bandwidth, determine the next resolution state as the target resolution state corresponding to the plurality of video streams; and
in response to the target transmission bandwidth corresponding to the next resolution state being greater than the target estimated bandwidth, re-perform, by taking the next resolution state as the current resolution state, the determining the next resolution state of the current resolution state based on the state degradation sequence.

19. The electronic device according to claim 17, wherein to determine the target transmission bandwidth corresponding to the next resolution state based on the actual transmission bitrate of each video stream, the one or more processors is configured to:
determine a first video stream of which a frame is droppable and a second video stream of which a frame is non-droppable;
determine a minimum transmission bitrate for transmitting a lowest layer of the first video stream based on an actual transmission bitrate of the first video stream; and
determine a minimum transmission bandwidth corresponding to the next resolution state based on the minimum transmission bitrate corresponding to the first video stream and an actual transmission bitrate of the second video stream, and determine the minimum transmission bandwidth as the target transmission bandwidth corresponding to the next resolution state.

20. A non-transitory storage medium comprising computer-executable instructions, wherein the computer-executable instructions, when executed by a computer processor, are configured to:
determine a target estimated bandwidth corresponding to a plurality of video streams;
determine a state degradation sequence corresponding to the plurality of video streams based on stream attribute information of each video stream, the state degradation sequence comprising a plurality of resolution states arranged in a degradation order, and each resolution state comprising a transmission resolution of each video stream;
perform resolution-degraded bandwidth allocation process based on the state degradation sequence corresponding to the plurality of video streams, a current transmission resolution of each video stream, and the target estimated bandwidth, to determine a degraded target resolution state corresponding to the plurality of video streams; and
transmit the plurality of video streams based on a target transmission resolution of each video stream in the target resolution state.
